(19) United States
(12) Patent Application Publication
(10) Pub. No.: US 2024/0402063 A1
(43) Pub. Date: Dec. 5, 2024

(54) BIOLOGICAL SAMPLE ANALYSIS DEVICE AND ABNORMALITY DETERMINATION METHOD

(71) Applicant: SONY GROUP CORPORATION, TOKYO (JP)

(72) Inventors: YUYA SUZUKI, TOKYO (JP); NAOHISA AOTO, TOKYO (JP); SHINJI TASHIRO, TOKYO (JP)

(21) Appl. No.: 18/695,233

(22) PCT Filed: Sep. 8, 2022
(86) PCT No.: PCT/JP2022/033729

§ 371 Date: Mar. 25, 2024

(30) Foreign Application Priority Data
Oct. 5, 2021 (JP) 2021-163873

(51) Int. Cl. G01N 15/1404; G01N 15/14; G01N 15/1429

(52) U.S. Cl. CPC G01N 15/1404; G01N 15/1429; G01N 2015/1418; G01N 2015/1486

(57) ABSTRACT

In the present technology, an object of the present disclosure is to provide a new technique for addressing the clogging in a flow channel through which a biological sample flows. The present disclosure provides a biological sample analysis device including an information processing unit configured to perform abnormality determination processing of detecting an abnormality in a flow channel through which a biological sample flows on the basis of clogging detection data, in which the clogging detection data is data related to the number of detected particles per unit time. The abnormality determination processing may include sorting area clogging determination processing for detecting clogging in a sorting area where the particles are sorted, supply area clogging determination processing for detecting clogging in a supply area for supplying the biological sample to the sorting area where the particles are sorted, or both the sorting area clogging determination processing and the supply area clogging determination processing.

### TECHNICAL FIELD

The present disclosure relates to a biological sample analysis device and an abnormality determination method. More specifically, the present disclosure relates to a biological sample analysis device having a flow channel through which a biological sample containing particles flows, and an abnormality determination method in the biological sample analysis device.

### BACKGROUND ART

For example, a particle population such as cells, microorganisms, and liposomes is labeled with a fluorescent dye, and the intensity and/or pattern of fluorescence generated from the fluorescent dye excited by irradiating each particle of the particle population with laser light is measured, thereby measuring the characteristics of the particles. As a representative example of a biological sample analysis device that performs the measurement, a flow cytometer can be mentioned.

The flow cytometer is a device that irradiates particles flowing in a line in a flow channel with laser light (excitation light) having a specific wavelength and detects fluorescence and/or scattered light emitted from each particle to analyze a plurality of particles one by one. The flow cytometer can convert light detected by a photodetector into an electrical signal, quantify the electrical signal, and perform statistical analysis to determine characteristics, for example, the type, size, structure, and the like of each particle. Particles having desired characteristics can also be sorted on the basis of the result of the determination.

The device has a flow channel through which the biological sample flows. Several technologies related to grasping the state in the flow channel and controlling the device have been proposed so far. For example, Patent Document 1 below discloses a microparticle measurement device including a detection unit that detects light from a microparticle sent from one of a plurality of containers containing microparticles, and an information processing unit that controls to specify a feature amount related to a detection number in a certain time section on the basis of information detected by the detection unit, determine that the feature amount is abnormal on the basis of a predetermined threshold, and finish the detection for the one container.

### CITATION LIST

### Patent Document

Patent Document 1: WO 2018/047442

### SUMMARY OF THE INVENTION

### Problems to be Solved by the Invention

In a biological particle analyzer such as a flow cytometer, clogging may occur in a microflow channel through which a sample flows. The clogging may be caused by, for example, aggregate of cells or dust contained in the sample. Such clogging may interfere with the analysis or may also interfere with the sorting of the target particles.

An object of the present disclosure is to provide a new technique for addressing the clogging in the flow channel through which a biological sample flows.

### Solutions to Problems

The present disclosure provides
a biological sample analysis device
including an information processing unit configured to perform abnormality determination processing of detecting an abnormality in a flow channel through which a biological sample flows on the basis of clogging detection data, in which
the clogging detection data is data related to the number of detected particles per unit time.

In one embodiment, the clogging detection data may include at least one of
data related to the number of detected particles sorted per unit time,
data related to the number of particles determined to be a sorting target per unit time and data related to the number of detected particles to be analyzed per unit time.

In one embodiment, the abnormality determination processing may include at least one of
sorting area clogging determination processing for detecting clogging in a sorting area where particles are sorted,
supply area clogging determination processing for detecting clogging in a supply area for supplying the biological sample to the sorting area, or
a bubble detection processing for detecting bubbles flowing in the flow channel.

The abnormality determination processing may include the bubble detection processing of detecting bubbles flowing in the flow channel.

In one embodiment, the abnormality determination processing may include sorting area clogging determination processing for detecting clogging in a sorting area where particles are sorted.

In the sorting area clogging determination processing, the clogging detection data referred to by the information processing unit may be data based on the number of particles determined to be sorting targets per unit time and the number of detected particles sorted per unit time. That is, the clogging detection data may be data based on the number of particles determined to be sorting targets per unit time and the number of detected particles sorted per unit time.

In the sorting area clogging determination processing, the information processing unit may refer to data based on a recovery rate of sorting target particles as the clogging detection data. That is, the clogging detection data may be data based on the recovery rate of the sorting target particles.

The information processing unit may compare the clogging detection data with a predetermined threshold to determine whether the clogging occurs in the sorting area.

The information processing unit may compare the clogging detection data with a predetermined threshold, and determine that the clogging occurs in the sorting area in a case where the clogging detection data is continuously detected to be equal to or less than the predetermined threshold or less than the predetermined threshold for a predetermined number of times, or in a case where the clogging detection data is detected a predetermined number of times or more within a predetermined time.

The information processing unit may cause the biological sample analysis device to perform the clogging removal processing in response to the determination that the clogging occurs in the sorting area.

In another embodiment, the abnormality determination processing may include a supply area clogging determination processing for detecting clogging in the supply area for supplying the biological sample to the sorting area where the particles are sorted.

In the supply area clogging determination processing, the information processing unit may refer to data related to a detection frequency of analysis target particles as the clogging detection data. That is, the clogging detection data may be data related to the detection frequency of analysis target particles.

The information processing unit may compare the clogging detection data with a predetermined threshold to determine whether the clogging occurs in the supply area.

The information processing unit may compare the clogging detection data with a predetermined threshold, and determine that the clogging occurs in the supply area in a case where the clogging detection data is continuously detected to be equal to or less than the predetermined threshold or less than the predetermined threshold for a predetermined number of times, or in a case where the clogging detection data is detected a predetermined number of times or more within a predetermined time.

In a case where it is determined that the clogging occurs in the supply area clogging determination processing, the information processing unit may perform bubble detection processing.

The bubble detection processing may be performed on the basis of scattered light generated by irradiating the analysis target particles with light.

The information processing unit may end sorting processing in a case where bubbles are detected in the bubble detection processing.

The information processing unit may cause the biological sample analysis device to perform clogging removal processing in response to the determination that the clogging occurs in the supply area.

Furthermore, the present disclosure
provides an abnormality determination method in a biological sample analysis device, the method including
performing abnormality determination processing of detecting an abnormality in a flow channel through which a biological sample flows on the basis of clogging detection data, in which
the clogging detection data is data related to the number of detected particles per unit time.

### BRIEF DESCRIPTION OF DRAWINGS

FIG. 1 is a graph for explaining changes in various indexes in a case where clogging occurs in a flow channel.

FIG. 2 is a diagram illustrating a configuration example of a biological sample analysis device of the present disclosure and a chip attached to the device.

FIG. 3 is a photograph showing clogging in the vicinity of a particle sorting unit and removal of the clogging.

FIG. 4 is a graph illustrating an example of a decrease in Event rate and an increase in bubble detect counter.

FIG. 5 is a photograph showing clogging in the vicinity of a junction and removal of the clogging.

FIG. 6 is a graph for explaining improvement of a reaching rate by a sheath liquid backflow processing.

FIG. 7 is a diagram illustrating a configuration example of a biological sample analysis device of the present disclosure.

FIG. 8 is a flowchart illustrating sorting processing performed by a biological sample analysis device of the present disclosure.

FIG. 9 is a diagram illustrating a configuration example of an information processing unit.

FIG. 10 is an enlarged view of a particle sorting unit.

FIG. 11 is a schematic perspective view of the vicinity of a connection flow channel.

FIG. 12 is a schematic cross-sectional view of the vicinity of a connection flow channel.

FIG. 13 is a schematic view illustrating a state in which a pressure change element is attached.

FIG. 14 is a flowchart illustrating abnormality determination processing.

FIG. 15 is a flowchart illustrating abnormality determination processing.

### MODE FOR CARRYING OUT THE INVENTION

Hereinafter, preferred modes for carrying out the present disclosure will be described. Note that embodiments to be described below illustrate representative embodiments of the present disclosure, and the scope of the present disclosure is not limited only to these embodiments. Note that the present disclosure will be described in the following order.
1. First embodiment (biological sample analysis device)
(1) Description of present disclosure
(2) Configuration example of device
(3) Configuration example of chip
(4) First example of abnormality determination processing
(5) Second example of abnormality determination processing
2. Second embodiment (abnormality determination method)

### 1. First Embodiment (Biological Sample Analysis Device)

### (1) Description of Present Disclosure

In order to prevent the occurrence of clogging described above, before the device analyzes the biological sample, processing of removing dust by causing a biological sample to pass through a predetermined filter is performed. However, since the size of the cell itself to be measured is about 10 μm, it may not be possible to completely remove dust having a size that can clog the microflow channel by using a filter that allows the cell to pass through.

With regard to the flow cytometer, a user can recognize that clogging has occurred with a decrease in Event rate or a stream abnormality of the sorted droplets (in the case of a droplet charge sorter). In a case where the clogging is detected, the clogging can be removed by performing processing such as priming the flow channel or causing bleach containing sodium hypochlorite to flow. Then, in a case where the clogging is not eliminated even when these processing are performed, the clogging can be removed by replacing a nozzle in a quartz flow cell device and replacing the chip in a plastic chip device.

However, such a method of removing such clogging may not be applicable. For example, in the case of a closed flow cytometer intended to develop or manufacture a cell therapeutic agent, there is a high possibility that the detection and removal of the clogging by the above-described method are not applicable as will described below.

First, in a case where the analysis processing or the sorting processing of the biological particles is performed for a long time, it is difficult for the user to continuously monitor the state of the device. Therefore, it is desirable to automatically detect clogging. Moreover, the decrease in Event rate may be caused not only by clogging in the flow channel but also by providing all the samples. Therefore, it is desirable that the cause of the decrease can be distinguished.

For example, cell processing processes for the development or manufacture of the cell therapeutic agent may take place for a long time. In addition, when processing for eliminating the clogging can be automatically performed according to the causes of clogging in order to improve productivity, downtime can be minimized.

Furthermore, even when a part of the flow channel is clogged, Event rate may not decrease. For example, when the structure of the flow channel becomes complicated, there is a case where the liquid can flow while avoiding the clogging even when the clogging occurs, and in this case, there is a high possibility that Event rate does not decrease. This problem is particularly related to, for example, a case where a closed microflow channel chip is utilized for particle sorting.

Furthermore, even when a part of the flow channel is clogged, the stream abnormality of the droplets may not be capable of being confirmed. This applies, for example, to the biological particle analyzer in which no droplets are formed. For example, in a case where the closed microflow channel chip is used for particle sorting, the droplets are not formed.

Furthermore, processing such as priming the flow channel or causing bleach containing sodium hypochlorite to flow may affect the sample itself. For example, biological particles such as cells are easily affected by these.

Furthermore, replacement of the chip or the nozzle may cause loss of the biological sample. The loss is not desirable in a case where the biological sample is valuable. For example, in the cell therapy field, samples are often patient-derived, and device users cannot tolerate such loss.

The biological sample analysis device according to the present disclosure includes an information processing unit that performs abnormality determination processing of detecting an abnormality in a flow channel through which a biological sample flows on the basis of clogging detection data. The clogging detection data used for the abnormality determination processing is data related to the number of detected particles per unit time. The clogging detection data may include at least one of data related to the number of detected particles sorted per unit time, data related to the number of particles determined to be sorting targets per unit time or data related to the number of detected particles to be analyzed per unit time.

Since the biological sample analysis device determines an abnormality in the flow channel on the basis of the change, the biological sample analysis device can automatically detect the clogging. Therefore, the device can automatically cope with the clogging. Furthermore, the clogging detection data generated using the number of detected particles per unit time (particularly, a change thereof) is suitable for detecting clogging in the flow channel.

The abnormality in the flow channel may be, for example, clogging in the flow channel, that is, a decrease in cross-sectional area in the flow channel.

The clogging in the flow channel may be clogging caused by the sample flowing in the flow channel, and in particular, may be clogging formed by a component in the sample, and may be, for example, biological particles (in particular, cells) in the sample, precipitates precipitated in a liquid in the sample, dust in the sample, or the like. The clogging may be clogging caused by such a component sticking to any position on the inner wall of the flow channel.

The information processing unit may be designed to specify a flow channel section of the flow channel in which an abnormality (particularly clogging) exists.

The flow channel section may be a flow channel section in the flow channel chip where the sorting processing is performed on the biological particles in the biological sample, particularly a flow channel section downstream of the light irradiation position of the detection optical system for determining whether the biological particles are sorted, more particularly, a flow channel section in the vicinity of a particle sorting unit to be described later. The flow channel section is also referred to as a sorting area in the present description.

Furthermore, the flow channel section may be a flow channel section for supplying the biological sample to a light irradiation position for determining whether the biological sample is sorted, and in particular, may be a flow channel section from a container containing the biological sample to a light irradiation position for determining whether the biological particles in the biological sample are sorted. The flow channel section is also referred to as a supply area.

The information processing unit may be designed to determine whether the abnormality (particularly, clogging) in the flow channel is an abnormality existing in the supply area or an abnormality existing in the sorting area. Therefore, it is possible to take a measure corresponding to the flow channel in which the abnormality exists, and for example, it is possible to automatically execute the abnormality handling processing (particularly, the clogging removal processing) corresponding to the abnormality.

In an embodiment of the present disclosure, the abnormality determination processing includes sorting area clogging determination processing for detecting clogging in a sorting area where particles are sorted. The sorting area clogging determination processing will be described below.

In a case where the clogging occurs in the sorting area of a microflow channel chip or the like, the number of particles detected per second (also referred to as Event rate) is not affected, and with Event rate, the occurrence of the clogging may not be capable of being detected.

The present inventors have found that in a case where the clogging occurs in the sorting area, since the sample delivery is disturbed, the cells are less likely to be drawn into the route for collection, and the value of the number of cells sorted per unit time (also referred to Sort rate) and the ratio of the number of actually sorted cells to the number of cells determined to be sorted (also referred to Recovery) decreases. Therefore, by monitoring these indexes, it is possible to automatically detect or determine clogging in the chip. The target to be monitored may be not only Sort rate and Recovery but also a moving average value calculated therefrom or a change rate thereof (also referred to Recovery change rate). By performing such monitoring, the occurrence of clogging in which a decrease in Event rate does not occur can be detected. Furthermore, such monitoring can be performed even by a closed flow cytometer with which disturbance of liquid delivery due to clogging cannot be visually observed, and the clogging can also be detected even by such a device.

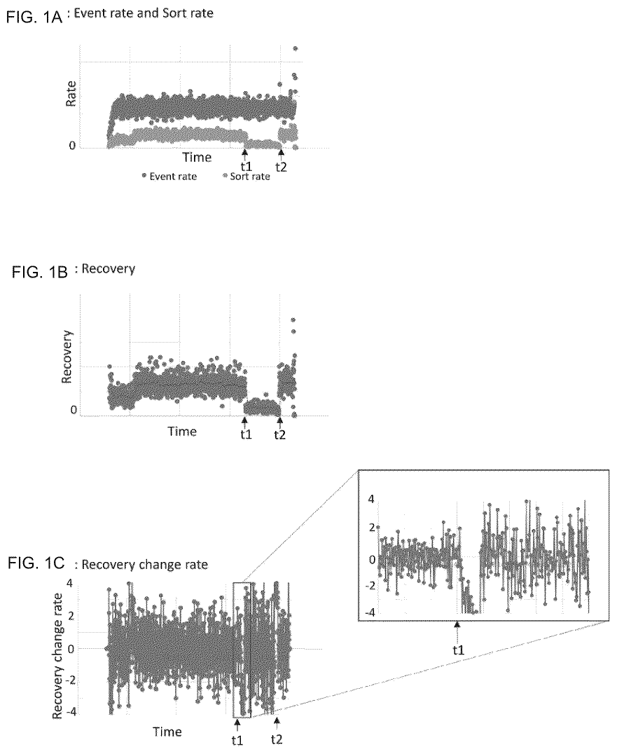

Changes in these indexes in a case where the clogging occurs in the sorting area will be described with reference to FIG. 1.

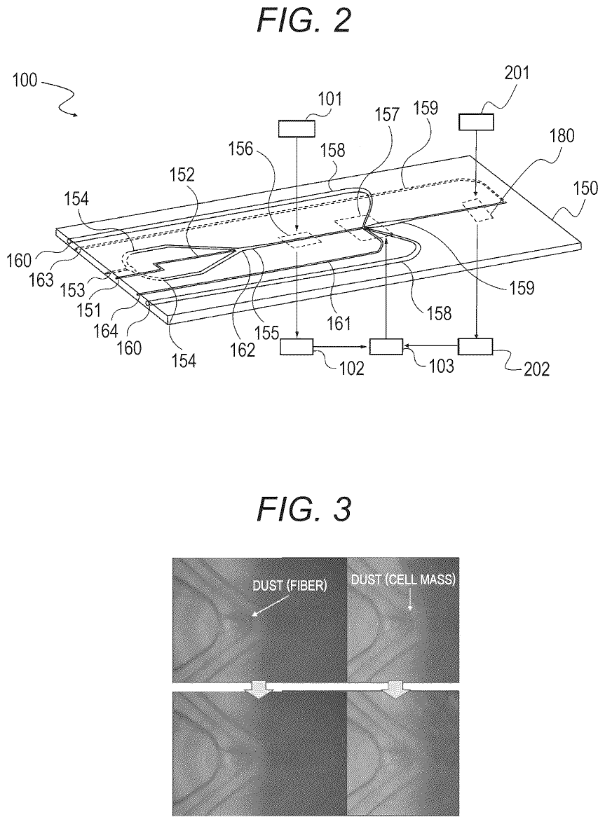

A graph A illustrated in FIG. 1 is a graph obtained by plotting Event rate and Sort rate with respect to time in a case where the clogging occurs in a cell sorting operation by a biological sample analysis device 100 illustrated in FIG. 2 to be described below. The vertical axis represents Event rate or Sort rate, and the horizontal axis represents time. At time t1, the clogging occurs in the sorting area since cells adhere to the flow channel wall surface, and at time t2, the clogging was eliminated. At time t1 of the graph A, Event rate does not change, but Sort rate decreases. Furthermore, at time t2, Event rate does not change, but the Sort rate returned to the level before the clogging occurs. As described above, even in a case where the clogging in the sorting area cannot be detected with Event rate, the clogging can be detected with Sort rate.

A graph B illustrated in FIG. 1 is a graph obtained by plotting Recovery with respect to time in a case where the clogging occurs in the cell sorting operation. The vertical axis represents Recovery, and the horizontal axis represents time. Also in the graph B, Recovery decreases at time t1, and Recovery returns to the level before the clogging occurs at time t2. As described above, even in a case where the clogging in the sorting area cannot be detected with Event rate, the clogging can be detected with Recovery.

A graph C illustrated in FIG. 1 is a graph obtained by plotting Recovery change rate with respect to time in a case where the clogging occurs in the cell sorting operation. The vertical axis represents Recovery change rate, and the horizontal axis represents time. As illustrated in the graph C (in particular, the enlarged view on the right side), Recovery change rate randomly changes until time t1, but is biased to the minus side in Recovery change rate at time t1. Furthermore, at time t2, Recovery change rate is biased to the plus side. As described above, the clogging in the sorting area can detected with Recovery change rate.

Furthermore, after the clogging is detected, the clogging can be eliminated by moving a liquid delivery control valve and/or a pump or a piezo element to change the liquid delivery direction in the chip and/or increase the internal pressure in the chip. Therefore, in a case where the clogging is detected by the sorting area clogging determination processing, it is also possible to automatically cope with the clogging. Removal of the clogging by such clogging removal processing will be described with reference to FIG. 3. FIG. 3 is a photograph of the vicinity of a particle sorting unit 157 of a chip 150 to be described later. In the upper photograph of FIG. 3, there is dust (fiber or cell mass) at the inlet of a connection flow channel 170, and the dust causes clogging. When the above-described clogging removal processing is performed on the chip in this state, dust is removed as illustrated in the lower photograph of FIG. 3. That is, the clogging in the chip can be removed by the clogging removal processing.

Furthermore, by the clogging removal processing, for example, the clogging upstream of the sorting area can be eliminated. This will be described with reference to FIG. 5. FIG. 5 is a photograph of the vicinity of a junction 162 where a sample liquid and a sheath liquid in the chip 150 to be described later join. In the upper photograph of FIG. 5, there is dust (cell mass) at the junction 162, and the dust causes clogging. When the above-described sheath liquid backflow processing is performed on the chip in this state, the dust is removed as illustrated in the lower photograph of FIG. 5. That is, the clogging in the chip can be removed by the clogging removal processing.

The sorting area clogging determination processing described above will be described in more detail in (4) below.

In another embodiment of the present disclosure, the abnormality determination processing includes supply area clogging determination processing for detecting clogging in the supply area for supplying the biological sample to the sorting area where the particles are sorted. The supply area clogging determination processing will be described below.

In a case where clogging of the flow channel occurs in the flow channel (for example, a flow channel through which the sample liquid flows from a container containing the sample liquid to the light irradiation position, in particular, a flow channel through which only the sample liquid flows) upstream of the light irradiation position of the detection optical system for determining whether the sorting is performed, the sample liquid does not reach the light irradiation position, and thus Event rate decreases. In this case, not only the number of sorted cells but also the number of cells subjected to the determination as to whether to sort decrease, and thus the value of Recovery does not significantly decrease. Therefore, by monitoring Event rate, it is possible to detect clogging in the flow channel as clogging in the sample liquid supply flow channel instead of clogging in the chip.

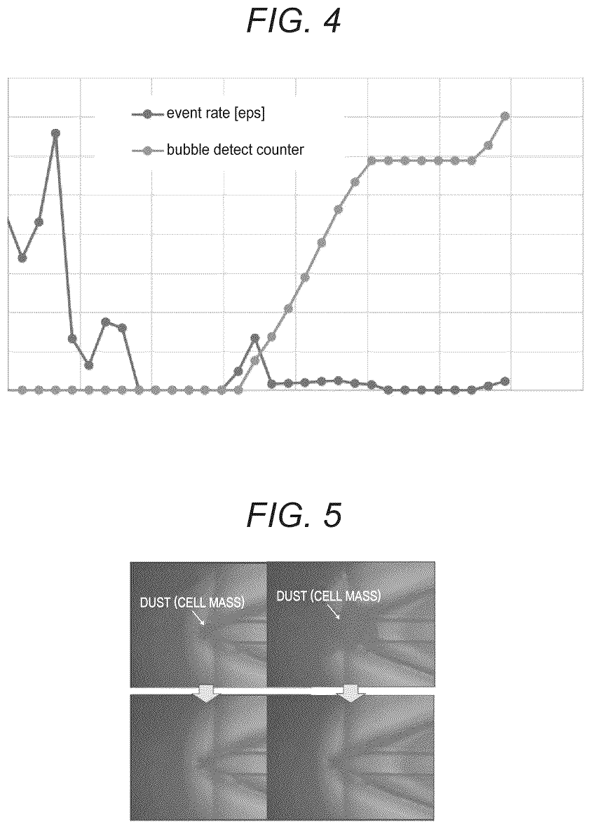

Here, the decrease in Event rate may occur not only due to clogging in the flow channel but also due to sample liquid shortage, that is, exhaustion of the sample liquid. Therefore, in a preferred embodiment of the present disclosure, a factor of a decrease in Event rate may be distinguished. Whether the decrease in Event rate is caused by sample liquid shortage may be determined by, for example, a method based on bubble detection described in Patent Document 1. In a case where the decrease in Event rate is caused by sample liquid shortage, air is sucked and bubbles flow into the chip as the amount of the sample liquid decreases and Event rate decreases. FIG. 4 illustrates an example of a decrease in Event rate and an increase in bubble detect counter in a case where the sample liquid shortage. In FIG. 4, the horizontal axis represents time, and the vertical axis represents Event rate or a bubble detect counter. In a case where the sample liquid shortage occurs, as illustrated in FIG. 4, an increase in bubble detect counter is observed following the decrease in Event rate. On the other hand, in the case of clogging in the sample liquid supply flow channel, the sample liquid cannot flow and Event rate decreases, but air is not sucked. Therefore, bubbles do not flow. Therefore, by performing bubble detection in addition to monitoring of Event rate, clogging in the sample liquid supply flow channel and the sample liquid shortage can be distinguished and detected. Then, different processing can be automatically performed according to the detected state.

Note that the sample liquid shortage may be detected by processing other than the bubble detection processing. For example, the device of the present disclosure may detect the sample liquid shortage by monitoring the state of the container containing the sample liquid (for example, an internal pressure or shape of the container). As the device for performing such monitoring, a device known in the technical field may be used.

In a case where the clogging in the sample liquid supply flow channel is detected, the device of the present disclosure can perform clogging removal processing. The device of the present disclosure can eliminate the clogging by performing the sheath liquid backflow processing of causing the sheath liquid to flow backward to the sample liquid supply flow channel, for example, by driving a liquid delivery control valve and/or pump.

Furthermore, in a case where the sample liquid shortage is detected, the device of the present disclosure may automatically end the analysis or sorting processing. Alternatively, the device of the present disclosure may perform the sheath liquid backflow processing to cause the cells accumulated or remaining in the sample liquid supply flow channel to flow to the sample liquid reservoir. Then, the analysis or sorting operation processing can be performed again. Thus, the number of cells to be subjected to the processing can be increased, and the recovery rate of the target cells is improved.

Furthermore, the sheath liquid backflow processing is not necessarily performed after the sample liquid runs out, and may be performed, for example, according to the elapse of a predetermined time. Therefore, the recovery rate can be increased.

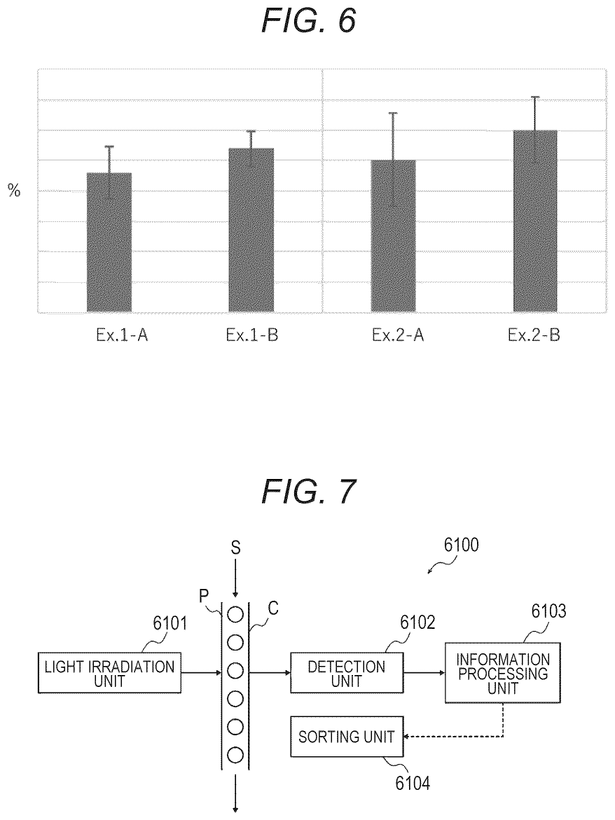

The improvement of the reaching rate of the cells in the sample liquid to the chip by the sheath liquid backflow processing will be described with reference to FIG. 6. The vertical axis in FIG. 6 represents the reaching rate of cells in the sample liquid to the chip.

In FIG. 6, Ex. 1-A is a reaching rate in a case where the sorting operation is performed without performing the sheath liquid backflow processing. Ex. 1-B is a reaching rate in a case where the sorting operation is performed in the same manner as in Ex. 1-A except that the sheath liquid backflow processing is performed. From these results, it is confirmed that the reaching rate is improved by the sheath liquid backflow processing.

Furthermore, in FIG. 6, Ex. 2-A is a reaching rate in a case where the sorting operation is performed under another condition without performing the sheath liquid backflow processing. Ex. 2-B is a reaching rate in a case where another sorting operation is performed in the same manner as in Ex. 2-A except that the sheath liquid backflow processing is performed. From these results, it is also confirmed that the reaching rate is improved by the sheath liquid backflow processing.

The supply area clogging determination processing described above will be described in more detail in (4) below.

In one embodiment, the abnormality determination processing may include at least one of sorting area clogging determination processing for detecting clogging in the sorting area where particles are sorted, supply area clogging determination processing for detecting clogging in the supply area for supplying the biological sample to the sorting area, or a bubble detection processing for detecting bubbles flowing in the flow channel. For example, the abnormality determination processing may include any one of the sorting area clogging determination processing, the supply area clogging determination processing, or the bubble detection processing. Furthermore, the abnormality determination processing may include the sorting area clogging determination processing, or may include the supply area clogging determination processing. Furthermore, the abnormality determination processing may include the bubble detection processing in addition to the supply area clogging determination processing.

In a particularly preferred embodiment of the present disclosure, the abnormality determination processing includes both the sorting area clogging determination processing and the supply area clogging determination processing. Therefore, it is possible to specify a flow channel section where the abnormality exists, and it is possible to automatically perform the abnormality handling processing (particularly, the clogging removal processing) corresponding to the abnormality. The abnormality determination processing may further include the bubble detection processing of detecting bubbles flowing in the flow channel. Moreover, the biological sample analysis device can automatically perform these processing.

In the present disclosure, the sorting area clogging determination processing may be performed first, and then the supply area clogging determination processing may be performed. Alternatively, the supply area clogging determination processing may be performed first, and then the sorting area clogging determination processing may be performed.

Hereinafter, first, a configuration example of the biological particle analyzer that performs abnormality determination processing according to the present disclosure will be described, and next, a more detailed example of the abnormality determination processing will be described.

### (2) Configuration Example of Device

FIG. 7 illustrates a configuration example of the biological sample analysis device of the present disclosure. A biological sample analysis device 6100 illustrated in FIG. 7 includes a light irradiation unit 6101 that irradiates a biological sample S flowing through a flow channel C with light, a detection unit 6102 that detects light generated by irradiating the biological sample S with light, and an information processing unit 6103 that processes information regarding the light detected by the detection unit. The biological sample analysis device 6100 is a flow cytometer or an imaging cytometer, for example. The biological sample analysis device 6100 may include a sorting unit 6104 that sorts out specific biological particles P in a biological sample. The biological sample analysis device 6100 including the sorting unit is a cell sorter, for example.

### (Biological Sample)

The biological sample S may be a liquid sample containing biological particles. The biological particles are cells or non-cellular biological particles, for example. The cells may be living cells, and more specific examples thereof include blood cells such as erythrocytes and leukocytes, and germ cells such as sperms and fertilized eggs. Also, the cells may be those directly collected from a sample such as whole blood, or may be cultured cells obtained after culturing. The non-cellular biological particles are extracellular vesicles, or particularly, exosomes and microvesicles, for example. The biological particles may be labeled with one or more labeling substances (such as a dye (particularly, a fluorescent dye) and a fluorochrome-labeled antibody). Note that particles other than biological particles may be analyzed by the biological sample analysis device of the present disclosure, and beads or the like may be analyzed for calibration or the like.

### (Flow Channel)

The flow channel C is designed so that a flow of the biological sample S is formed. In particular, the flow channel C may be designed so that a flow in which the biological particles contained in the biological sample are aligned substantially in one row is formed. The flow channel structure including the flow channel C may be designed so that a laminar flow is formed. In particular, the flow channel structure is designed so that a laminar flow in which the flow of the biological sample (a sample flow) is surrounded by the flow of a sheath liquid is formed. The design of the flow channel structure may be appropriately selected by a person skilled in the art, or a known one may be adopted. The flow channel C may be formed in a flow channel structure such as a microchip (a chip having a flow channel on the order of micrometers) or a flow cell. The width of the flow channel C is 1 mm or smaller, or particularly, may be not smaller than 10 μm and not greater than 1 mm. The flow channel C and the flow channel structure including the flow channel C may be made of a material such as plastic or glass.

The biological sample analysis device of the present disclosure is designed so that the biological sample flowing in the flow channel C, or particularly, the biological particles in the biological sample are irradiated with light from the light irradiation unit 6101. The biological sample analysis device of the present disclosure may be designed so that the irradiation point of light on the biological sample is located in the flow channel structure in which the flow channel C is formed, or may be designed so that the irradiation point is located outside the flow channel structure. An example of the former case may be a configuration in which the light is emitted onto the flow channel C in a microchip or a flow cell. In the latter case, the biological particles after exiting the flow channel structure (particularly, the nozzle portion thereof) may be irradiated with the light, and a flow cytometer of a jet-in-air type can be adopted, for example.

### (Light Irradiation Unit)

The light irradiation unit 6101 includes a light source unit that emits light, and a light guide optical system that guides the light to the irradiation point. The light source unit includes one or more light sources. The type of the light source(s) is a laser light source or an LED, for example. The wavelength of light to be emitted from each light source may be any wavelength of ultraviolet light, visible light, and infrared light. The light guide optical system includes optical components such as beam splitters, mirrors, or optical fibers, for example. The light guide optical system may also include a lens group for condensing light, and includes an objective lens, for example. There may be one or more irradiation points at which the biological sample and light intersect. The light irradiation unit 6101 may be designed to collect light emitted onto one irradiation point from one light source or different light sources.

### (Detection Unit)

The detection unit 6102 includes at least one photodetector that detects light generated by emitting light onto biological particles. The light to be detected may be fluorescence or scattered light (such as one or more of the following: forward scattered light, backscattered light, and side scattered light), for example. Each photodetector includes one or more light receiving elements, and has a light receiving element array, for example. Each photodetector may include one or more photomultiplier tubes (PMTs) and/or photodiodes such as APDs and MPPCs, as the light receiving elements. The photodetector includes a PMT array in which a plurality of PMTs is arranged in a one-dimensional direction, for example. The detection unit 6102 may also include an image sensor such as a CCD or a CMOS. With the image sensor, the detection unit 6102 can acquire an image (such as a bright-field image, a dark-field image, or a fluorescent image, for example) of biological particles.

The detection unit 6102 includes a detection optical system that causes light of a predetermined detection wavelength to reach the corresponding photodetector. The detection optical system includes a spectroscopic unit such as a prism or a diffraction grating, or a wavelength separation unit such as a dichroic mirror or an optical filter. The detection optical system is designed to disperse the light generated by light irradiation to biological particles, for example, and detect the dispersed light with a larger number of photodetectors than the number of fluorescent dyes with which the biological particles are labeled. A flow cytometer including such a detection optical system is called a spectral flow cytometer. Further, the detection optical system is designed to separate the light corresponding to the fluorescence wavelength band of a specific fluorescent dye from the light generated by the light irradiation to the biological particles, for example, and cause the corresponding photodetector to detect the separated light.

The detection unit 6102 may also include a signal processing unit that converts an electrical signal obtained by a photodetector into a digital signal. The signal processing unit may include an A/D converter as a device that performs the conversion. The digital signal obtained by the conversion performed by the signal processing unit can be transmitted to the information processing unit 6103. The digital signal can be handled as data related to light (hereinafter, also referred to as “light data”) by the information processing unit 6103. The light data may be light data including fluorescence data, for example. More specifically, the light data may be data of light intensity, and the light intensity may be light intensity data of light including fluorescence (the light intensity data may include feature quantities such as area, height, and width).

### (Information Processing Unit)

The information processing unit 6103 includes a processing unit that performs processing of various kinds of data (light data, for example), and a storage unit that stores various kinds of data, for example. In a case where the processing unit acquires the light data corresponding to a fluorescent dye from the detection unit 6102, the processing unit can perform fluorescence leakage correction (a compensation process) on the light intensity data. In the case of a spectral flow cytometer, the processing unit also performs a fluorescence separation process on the light data, and acquires the light intensity data corresponding to the fluorescent dye. The fluorescence separation process may be performed by an unmixing method disclosed in JP 2011-232259 A, for example. In a case where the detection unit 6102 includes an image sensor, the processing unit may acquire morphological information about the biological particles, on the basis of an image acquired by the image sensor. The storage unit may be designed to be capable of storing the acquired light data. The storage unit may be designed to be capable of further storing spectral reference data to be used in the unmixing process.

In a case where the biological sample analysis device 6100 includes the sorting unit 6104 described later, the information processing unit 6103 can determine whether to sort the biological particles, on the basis of the light data and/or the morphological information. The information processing unit 6103 then controls the sorting unit 6104 on the basis of the result of the determination, and the biological particles can be sorted by the sorting unit 6104.

The information processing unit 6103 may be designed to be capable of outputting various kinds of data (such as light data and images, for example). For example, the information processing unit 6103 can output various kinds of data (such as a two-dimensional plot or a spectrum plot, for example) generated on the basis of the light data. The information processing unit 6103 may also be designed to be capable of accepting inputs of various kinds of data, and accepts a gating process on a plot by a user, for example. The information processing unit 6103 may include an output unit (such as a display, for example) or an input unit (such as a keyboard, for example) for performing the output or the input.

The information processing unit 6103 may be designed as a general-purpose computer, and may be designed as an information processing device that includes a CPU, a RAM, and a ROM, for example. The information processing unit 6103 may be included in the housing in which the light irradiation unit 6101 and the detection unit 6102 are included, or may be located outside the housing. Further, the various processes or functions to be executed by the information processing unit 6103 may be realized by a server computer or a cloud connected via a network.

### (Sorting Unit)

The sorting unit 6104 performs sorting of biological particles, in accordance with the result of determination performed by the information processing unit 6103. The sorting method may be a method by which droplets containing biological particles are generated by vibration, electric charges are applied to the droplets to be sorted, and the traveling direction of the droplets is controlled by an electrode. The sorting method may be a method for sorting by controlling the traveling direction of biological particles in the flow channel structure. The flow channel structure has a control mechanism based on pressure (injection or suction) or electric charge, for example. An example of the flow channel structure may be a chip (the chip disclosed in JP 2020-76736 A, for example) that has a flow channel structure in which the flow channel C branches into a recovery flow channel and a waste liquid flow channel on the downstream side, and specific biological particles are collected in the recovery flow channel.

### (3) Configuration Example of Chip

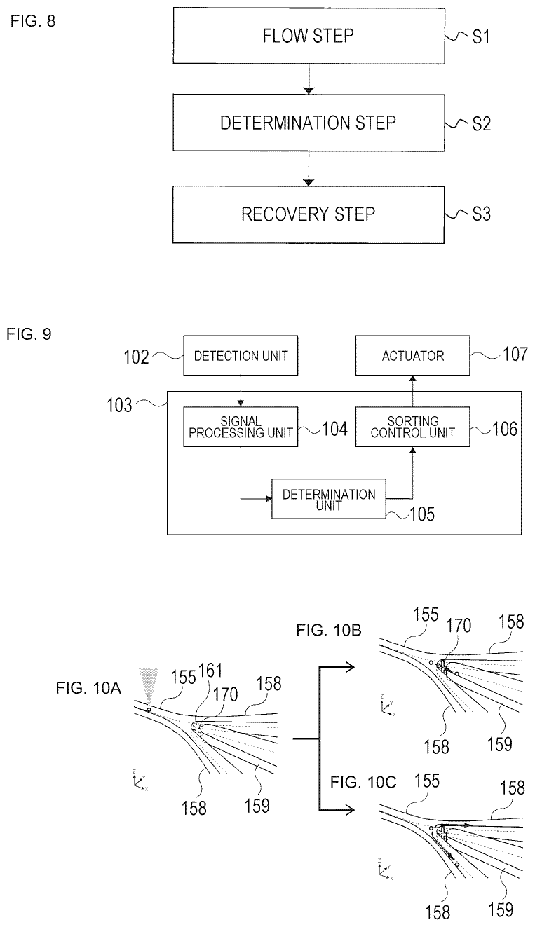

The biological sample analysis device according to the present disclosure may be designed as, for example, a device that sorts biological particles by controlling a flow channel through which the biological particles flow, and may be particularly designed as a device that sorts the biological particles in a closed space. FIG. 2 illustrates a configuration example of the biological sample analysis device. FIG. 2 also illustrates an example of a flow channel structure of a biological particle sorting microchip (hereinafter also referred to as a “chip”) attached to the device. FIG. 8 is a flowchart illustrating sorting processing performed by the biological particle analyzer.

The biological sample analysis device 100 illustrated in FIG. 2 includes a first light irradiation unit 101, a first detection unit 102, and an information processing unit 103. The first light irradiation unit 101, the first detection unit 102, and the information processing unit 103 are the light irradiation unit 6101, the detection unit 6102, and the information processing unit 6103, which are described above, and the description is also applied to the same drawing. Note that as illustrated in FIG. 9, the information processing unit 103 may include a signal processing unit 104, a determination unit 105, and a sorting control unit 106. Moreover, the biological sample analysis device 100 includes a second light irradiation unit 201 and a second detection unit 202, and the descriptions of the light irradiation unit 6101 and the detection unit 6102, which are described above, also apply to these. Note that specific configurations of the second light irradiation unit 201 and the second detection unit 202 may be different from those of the first light irradiation unit 101 and the first detection unit 102, respectively. This is because, as will described later, the data to be acquired by the second light irradiation unit 201 and the second detection unit 202 is different from the data to be acquired by the first light irradiation unit 101 and the first detection unit 102.

The biological sample analysis device 100 further includes a chip 150. The chip 150 may be included as a component of the sorting unit 6104 described above. The chip 150 may be attached to the biological sample analysis device 100 in an exchangeable manner.

Hereinafter, first, the biological particle sorting microchip 150 will be described, and next, the sorting operation by the biological sample analysis device 100 will be described.

The biological particle sorting microchip 150 illustrated in FIG. 2 includes a sample liquid flow channel 152 and a sheath liquid flow channel 154 that joins the sample liquid flow channel 152 at a junction 162. The biological particle sorting microchip 150 further include a sample liquid inlet 151 and a sheath liquid inlet 153.

Note that in FIG. 1, a part of the sheath liquid flow channel 154 is indicated by a dotted line. The portion indicated by the dotted line is located at a position lower than that of the sample liquid flow channel 152 indicated by a solid line (position displaced in an optical axis direction as indicated by an arrow extending from reference sign 101 to reference sign 102), and the flow channels do not communicate with each other at a position where the flow channel indicated by the dotted line intersects the flow channel indicated by the solid line. Furthermore, in FIG. 2, the sample liquid flow channel 152 is illustrated to bend twice between the sample liquid inlet 151 and the junction 162, which makes it easy to distinguish between the sample liquid flow channel 152 and the sheath liquid flow channel 154. The sample liquid flow channel 152 may be formed linearly without bending in this manner between the sample liquid inlet 151 and the junction 162.

In the biological particle sorting operation, a sample liquid containing biological particles is introduced from the sample liquid inlet 151 into the sample liquid flow channel 152, and a sheath liquid not including the biological particles is introduced from the sheath liquid inlet 153 into the sheath liquid flow channel 154.

The biological particle sorting microchip 150 includes a joined flow channel 155 including the junction 162 on one end thereof. The joined flow channel 155 includes a sorting discrimination unit 156 used for performing sorting discrimination of the biological particles (hereinafter, referred to as a “first detection region 156”).

In the biological particle sorting operation, the sample liquid and the sheath liquid join at the junction 162, then flow in the joined flow channel 155 toward a particle sorting unit 157. Particularly, the sample liquid and the sheath liquid join at the junction 162 to form, for example, a laminar flow in which the sample liquid is surrounded by the sheath liquid. Preferably, in the laminar flow, the biological particles are arrayed substantially in a line. Due to the flow channel structure in which the sample liquid flow channel 152 and two sheath liquid flow channels 154 join at the junction 162, the flow channel structure including the joined flow channel 155 of which one end is the junction 162, the laminar flow including the biological particles that flow substantially in a line is formed.

The biological particle sorting microchip 150 further includes the particle sorting unit 157 at the other end of the joined flow channel 155. FIG. 10 is an enlarged view of the particle sorting unit 157. As illustrated in A of FIG. 10, at the other end, the joined flow channel 155 is connected to a biological particle recovery flow channel 159 via a connection flow channel 170. As illustrated in A of FIG. 10, the joined flow channel 155, the connection flow channel 170, and the biological particle recovery flow channel 159 may be coaxial with each other.

In a case where a recovery target particles (also referred to as “sorting target particles” in the present description) flows to the particle sorting unit 157, as illustrated in B of FIG. 10, a flow to enter the biological particle recovery flow channel 159 from the joined flow channel 155 through the connection flow channel 170 is formed, and the recovery target particles are recovered into the biological particle recovery flow channel 159. In this manner, the recovery target particles flow to the biological particle recovery flow channel 159 through the connection flow channel 170. In a case where the biological particles that are not the recovery target particles flow to the particle sorting unit 157, the biological particles that are not the recovery target particles flow to any one of two branching flow channels 158 as illustrated in C of FIG. 10. In this case, the flow to enter the biological particle recovery flow channel 159 is not formed. As described above, the biological particle sorting microchip 150 includes two branching flow channels 158 connected to the joined flow channel 155 at the other end of the joined flow channel 155.

As illustrated in FIG. 2, the biological particle sorting microchip 150 includes an introduction flow channel 161 for introducing the liquid into the connection flow channel 170.

As the liquid is introduced from the introduction flow channel 161 into the connection flow channel 170, the connection flow channel 170 is filled with the liquid. Therefore, it is possible to prevent unintended biological particles from entering the biological particle recovery flow channel 159.

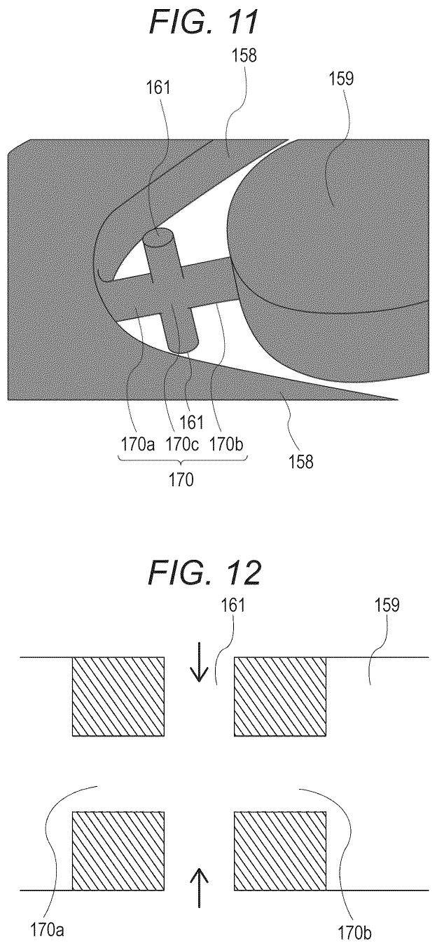

The introduction flow channel 161 and the connection flow channel 170 will be described with reference to FIGS. 11 and 12. FIG. 11 is a schematic perspective view of the vicinity of the connection flow channel 170. FIG. 12 is a schematic cross-sectional view on a plane passing through a center line of the introduction flow channel 161 and a center line of the connection flow channel 170. The connection flow channel 170 includes a flow channel 170a on a side of the sorting discrimination unit 156 (hereinafter, also referred to as an upstream side connection flow channel 170a), a flow channel 170b on a side of the biological particle recovery flow channel 159 (hereinafter, also referred to as a downstream side connection flow channel 170b), and a connection 170c between the connection flow channel 170 and the introduction flow channel 161. The introduction flow channel 161 is provided so as to be substantially perpendicular to an axis of the flow channel of the connection flow channel 170. In FIGS. 11 and 12, two introduction flow channels 161 are provided so as to face each other at substantially the center position of the connection flow channel 170, but only one introduction flow channel may be provided.

The liquid is supplied from two introduction flow channels 161 to the connection flow channel 170 as indicated by arrows in FIG. 12. The liquid flows from the connection 170c to both the upstream side connection flow channel 170a and the downstream side connection flow channel 170b.

In a case where the recovery step is not performed, the liquid flows as below.

The liquid that flows to the upstream side connection flow channel 170a exits from a connection surface to the joined flow channel 155 of the connection flow channel 170, and then flows separately to two branching flow channels 158. Since the liquid exits from the connection surface in this manner, it is possible to prevent the liquid and the biological particles that do not need to be recovered into the biological particle recovery flow channel 159 from entering the biological particle recovery flow channel 159 through the connection flow channel 170.

The liquid that flows to the downstream side connection flow channel 170b flows into the biological particle recovery flow channel 159. Therefore, the biological particle recovery flow channel 159 is filled with the liquid.

Also in a case where the recovery step is performed, the liquid may be supplied from two introduction flow channels 161 to the connection flow channel 170. However, due to pressure fluctuation in the biological particle recovery flow channel 159, particularly, by generating a negative pressure in the biological particle recovery flow channel 159, a flow from the joined flow channel 155 to the biological particle recovery flow channel 159 through the connection flow channel 170 is formed. That is, a flow is formed from the joined flow channel 155 to the biological particle recovery flow channel 159 through the upstream side connection flow channel 170a, the connection 170c, and the downstream side connection flow channel 170b in this order. Therefore, the recovery target particles are recovered into the biological particle recovery flow channel 159.

As illustrated in FIG. 2, the biological particle recovery flow channel 159 is formed so as to extend linearly from the particle sorting unit 157, make a U-turn, then reach the same surface as a surface on which the sample liquid inlet 151 and the sheath liquid inlet 153 are formed. The liquid that flows through the biological particle recovery flow channel 159 is discharged out of the chip from a recovery flow channel terminal 163.

As illustrated in FIG. 2, two branching flow channels 158 are also formed so as to extend linearly from the particle sorting unit 157, make a U-turn, and then reach the same surface as the surface on which the sample liquid inlet 151 and the sheath liquid inlet 153 are formed. The liquid that flows through each of the branching flow channels 158 is discharged out of the chip from a branching flow channel terminal 160.

In FIG. 2, a display method of the biological particle recovery flow channel 159 is changed from a solid line to a dotted line at the U-turn portion. This change indicates that the position in the optical axis direction changes on the way. Since the position is changed in the optical axis direction in this manner, the biological particle recovery flow channel 159 does not communicate with the branching flow channels 158 in a portion intersecting with the branching flow channels 158.

The recovery flow channel terminal 163 and two branching flow channel terminals 166 are all formed on the surface on which the sample liquid inlet 151 and the sheath liquid inlet 153 are formed. Moreover, an introduction flow channel inlet 164 for introducing the liquid into the introduction flow channel 161 to be described later is also formed on the surface. In this manner, in the biological particle sorting microchip 150, all of the inlet from which the liquid is introduced and the outlet from which the liquid is discharged are formed on one surface. Therefore, attachment of the chip to the biological sample analysis device 100 becomes easy. For example, as compared with a case where the inlet and/or outlet are formed on two or more surfaces, connection between the flow channel provided on the biological sample analysis device 100 and the flow channel of the biological particle sorting microchip 150 becomes easy.

FIG. 8 is a flowchart illustrating processing performed on the biological particles. As illustrated in FIG. 8, the biological particle sorting operation using the biological particle sorting microchip 150 includes a flow step S1 of allowing the liquid containing the biological particles to flow through the joined flow channel 155, a determination step S2 of determining whether the biological particles that flow through the joined flow channel 155 are the recovery target particles, and a recovery step S3 of recovering the recovery target particles into the biological particle recovery flow channel 159.

Each step is described below.

### (3-1) Flow Step

In the flow step S1, the sample liquid containing the biological particles and the sheath liquid not containing the biological particles are introduced from the sample liquid inlet 151 and the sheath liquid inlet 153 into the sample liquid flow channel 152 and the sheath liquid flow channel 154, respectively. The sample liquid may be, for example, a biological sample containing biological particles, and particularly may be a biological sample containing biological particles such as cells.

### (3-2) Determination Step

In the determination step S2, it is determined whether the biological particles that flow through the joined flow channel 155 are the recovery target particles. Specifically, the first detection unit 102 detects light generated by the light irradiation to the biological particles by the first light irradiation unit 101. The information processing unit 103 (particularly, the determination unit 105) may perform the determination on the basis of the light generated by the light irradiation of the biological particles with light by the first light irradiation unit 101. Furthermore, the information processing unit 103 generates data related to the number of detected particles per unit time on the basis of the detected light (particularly, on the basis of the number of times of detection of light).

The signal processing unit 104 included in the information processing unit 103 may process a waveform of the digital electrical signal obtained by the detection unit 102 to generate information (data) regarding a feature of the light used for the determination by the determination unit 105. As the information regarding the feature of the light, the signal processing unit 104 may acquire, for example, one, two, or three of a width of the waveform, a height of the waveform, and an area of the waveform from the waveform of the digital electrical signal. Furthermore, the information regarding the feature of the light may include, for example, time when the light is detected.

On the basis of the light generated by irradiating the biological particle that flows in the flow channel with light, a determination unit 105 included in an information processing unit 103 determines whether the biological particle is the recovery target particle. The determination may be performed, for example, by whether the information regarding the feature of the light meets a reference designated in advance. The reference may be a reference indicating that the biological particles are recovery target particles, and may be so-called gate information.

### (3-3) Recovery Step

In the recovery step S3, the biological particles determined to be the recovery target particles in the determination step S2 are recovered into the biological particle recovery flow channel 159. The recovery step S3 is performed in the particle sorting unit 157 in the chip 150. In the particle sorting unit 157, the laminar flow that flows through the joined flow channel 155 separately flows to two branching flow channels 158.

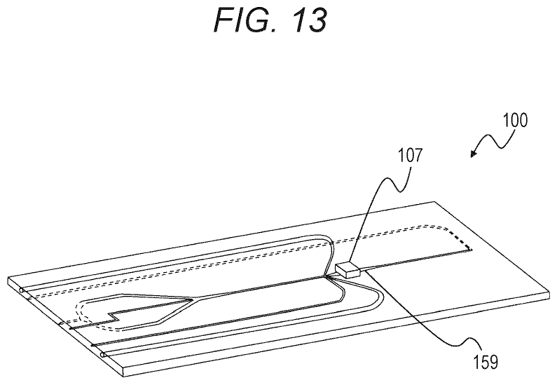

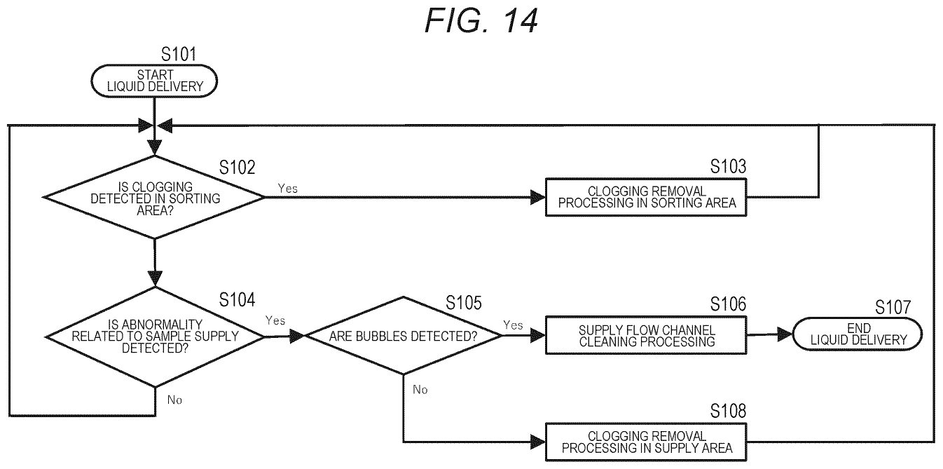

In the recovery step S3, due to the pressure fluctuation in the biological particle recovery flow channel 159, the recovery target particles are recovered into the biological particle recovery flow channel through the connection flow channel. The recovery may be performed, for example, by generating the negative pressure in the biological particle recovery flow channel 159 as described above. For example, as illustrated in FIG. 13, the negative pressure can be generated when a wall defining the biological particle recovery flow channel 159 is deformed by the pressure change element (also referred to as an actuator) 107 attached to the outside of the microchip 150. The information processing unit 103, in particular, the sorting control unit 106 can drive the pressure change element 107 to deform the wall. The pressure change element 107 may be, for example, a piezo actuator. The negative pressure may form the flow entering the biological particle recovery flow channel 159. In this manner, the recovery target particles are sorted in the particle sorting unit 157 and recovered into the biological particle recovery flow channel 159.

The biological particle recovery flow channel 159 includes a detection region 180 for detecting the recovered biological particles. The light irradiation unit 201 irradiates the recovered biological particles with light in the detection region 180. Then, the detection unit 202 detects light generated by the light irradiation. The detection unit 202 transmits information regarding the detected light to the information processing unit 103. The information processing unit 103 generates, for example, data of the second detection particle number per unit time to be described later on the basis of the information.

### (4) First Example of Abnormality Determination Processing

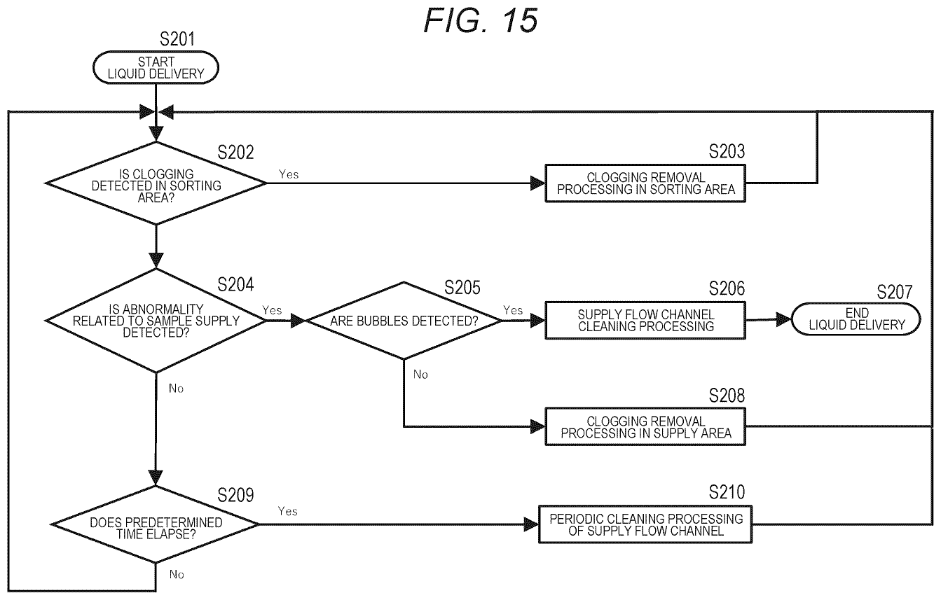

An example of the abnormality determination processing executed by the biological sample analysis device according to the present disclosure will be described below with reference to FIGS. 2 and 14. FIG. 2 is as described above, and illustrates a configuration example of the chip 150. FIG. 14 is a flowchart of the abnormality determination processing.

In the first detection region 156 and the second detection region 180 of the chip 150 illustrated in FIG. 2, light irradiation and detection of light generated by the light irradiation are performed.

In the first detection region 156, the biological particles flowing in the joined flow channel 155 are irradiated with light. That is, the biological particles contained in the sample liquid are detected and analyzed by light irradiation in the first detection region 156.

In the second detection region 180, the biological particles flowing in the biological particle recovery flow channel 159 are irradiated with light. That is, the sorted biological particles are detected by light irradiation in the second detection region 180.

The number of detected particles in these two detection regions (particularly, the number of detected particles per unit time) can be used to detect an abnormality in the flow channel through which the biological particles flow. That is, the biological sample analysis device according to the present disclosure is designed to perform abnormality determination processing of detecting an abnormality in the flow channel on the basis of the number of detected particles in two detection regions (particularly, the number of detected particles per unit time). A flow of the abnormality determination processing will be described below.

In step S101 illustrated in FIG. 14, the biological sample analysis device 100 starts delivering the sample liquid. The liquid delivery of the sheath liquid may be started before the start of the liquid delivery of the sample liquid, or may be started simultaneously with the start of the liquid delivery of the sample liquid. As described above, with the liquid delivery, the sample liquid and the sheath liquid join at the junction 162, and then flow in the joined flow channel 155 toward the particle sorting unit 157. As described above, the first detection region 156 exists on the joined flow channel 155. In the first detection region 156, the first light irradiation unit 101 irradiates the biological particles in the sample liquid with light. Then, the first detection unit 102 detects light generated by the light irradiation. The information processing unit 103 generates data related to the number of detected particles per unit time on the basis of the detected light (particularly, on the basis of the number of times of detection of light).

Furthermore, the biological sample analysis device 100 determines whether the biological particles are sorted on the basis of light generated by irradiating the biological particles in the first detection region 156 with light. The biological sample analysis device 100 recovers the biological particles determined to be sorted into the biological particle recovery flow channel 159. The recovered biological particles flow in the biological particle recovery flow channel 159. As described above, in the biological particle recovery flow channel 159, the second detection region 180 exists. In the second detection region 180, the second light irradiation unit 201 irradiates the particles flowing in the recovery flow channel 159 with light. Then, the second detection unit 202 detects light generated by the light irradiation. The information processing unit 103 generates data related to the number of detected particles per unit time on the basis of the detected light (particularly, on the basis of the number of times of detection of light).

In the present description, the unit time may be, for example, one second, but is not limited thereto. For example, the unit time may be any one of one second to 60 seconds, and may be appropriately selected.

In step S102, the biological sample analysis device 100 (particularly, the information processing unit 103) performs the sorting area clogging determination processing for detecting clogging in the sorting area where particles are sorted. The information processing unit 103 detects the clogging on the basis of a change in clogging detection data. Here, the clogging detection data may be data related to the number of detected particles per unit time in the second detection region 180.

The biological sample analysis device 100 may acquire the data every predetermined time, and may acquire the data, for example, every 0.1 seconds to 10 seconds, particularly every 0.5 seconds to five seconds, and more particularly every one second. In this way, by acquiring the data every predetermined time, a change in the data can be easily obtained, and the clogging can be more reliably detected.

The sorted particles are detected in the second detection region 180. A change in data related to the number of detected particles per unit time in the second detection region 180 (hereinafter also referred to as “second detection particle number”) is useful for detecting the clogging in the sorting area. By detecting a change in the data related to the second detection particle number, the clogging can be detected, and further, it can be specified that the clogging exists in the sorting area (for example, in the chip 150).

In step S102, the information processing unit 103 may compare the clogging detection data with a predetermined threshold in order to determine whether the clogging occurs.

For example, in step S102, the information processing unit 103 may compare the clogging detection data with a predetermined threshold to determine whether the clogging occurs in the sorting area. For example, the information processing unit 103 may determine that the clogging occurs in the sorting area in a case where the value used as the clogging detection data is equal to or less than a predetermined threshold or less than a predetermined threshold, or equal to or more than a predetermined threshold or more than a predetermined threshold.

That is, the change in the clogging detection data for determining the occurrence of the clogging may indicates that the clogging detection data is equal to or less than a predetermined threshold or less than a predetermined threshold, or equal to or more than a predetermined threshold or more than a predetermined threshold.

The data related to the second detection particle number may be, for example, the “number of detected particles sorted per unit time” itself, or may be data based on the “number of detected particles sorted per unit time” and the “number of particles determined to be the sorting targets on the basis of the light detection result in the first detection region 156 per unit time”.

Here, the “number of detected particles sorted per unit time” corresponds to the “second detection particle number per unit time” described above, and is also referred to as Sort rate.

Furthermore, in the present description, the “number of particles determined to be the sorting targets on the basis of the light detection result in the first detection region 156 per unit time” is also simply referred to as the “number of particles determined to be sorting targets per unit time”.

Preferably, the data related to the second detection particle number is data based on the “number of particles determined to be the sorting targets per unit time” and the “second detection particle number per unit time (that is, the number of detected particles sorted per unit time)”. The data is useful for detecting the occurrence of clogging in the sorting area.

In one embodiment, the data related to the second detection particle number may be data based on the recovery rate of the sorting target particles, which is represented by the following mathematical formula.

Recovery rate (Recovery)=(Second detection particle number unit time)/(Number of particles determined to be sorting targets per unit time)

The data based on the recovery rate is useful for detecting the occurrence of clogging in the sorting area.

The data based on the recovery rate may be any of pieces of the data described below:
a recovery rate per se;
a change rate of the recovery rate;
an average value of a plurality of recovery rates acquired in a predetermined time;
a change rate of the average value of a plurality of the recovery rates acquired in a predetermined time; and
a ratio between an average value of a plurality of the recovery rates acquired in a predetermined time and a reference average value.

Furthermore, the data based on the recovery rate may be a maximum value, a minimum value, or both of these values within a predetermined time. For example, the data based on the recovery rate may be a maximum value of the recovery rate, a minimum value of the recovery rate, or both of these values of the recovery rates, or a value calculated using the maximum value and the minimum value (for example, a difference thereof or a ratio of the difference to the maximum value).

Such data is useful for detecting the occurrence of clogging in the sorting area. Regarding the average value, the predetermined time may be appropriately set, but the predetermined time may range from, for example, five seconds to five minutes, 10 seconds to three minutes, or 20 seconds to two minutes.

The average value may be a moving average value of the recovery rate (or an inverse thereof) continuously acquired in a predetermined time. For example, the recovery rate is acquired every one second, and the moving average value of 30 recovery rates acquired over 30 seconds may be used as the average value.

Furthermore, the change rate of the average value may be a value indicating how much the recovery rate (or the average value thereof) acquired at a certain time point has changed as compared with the recovery rate (or the average value thereof) acquired at a previous time point. For example, the change rate may be a value represented by the following formula.

Change rate=(Difference between recovery rate (or average value of recovery rates) acquired at certain time point and recovery rate (or average value of recovery rates) acquired at previous time point)/(recovery rate (or average value of recovery rates) acquired at previous time point).

Regarding the ratio between the average value and the reference average value, the reference average value may be any average value of the recovery rates in a time zone in which clogging does not occur, and may be, for example, an average value of the recovery rates acquired first after the sorting processing is started. The reference average value may be changed every time a predetermined time elapses, or may be changed every time the change is detected.

Note that regarding the example of the data based on the recovery rate described above, the inverse of the recovery rate may be used instead of the recovery rate. That is, the inverse of the recovery rate, the change rate of the inverse of the recovery rate, the average value of the inverse of the recovery rates, the change rate of the average value, or the ratio between the average value and the reference average value may be used as the data based on the recovery rate.

The information processing unit 103 acquires data related to the second detection particle number at predetermined time intervals, and compares the data with a predetermined threshold.

In one embodiment, the information processing unit 103 determines that the clogging occurs in the sorting area in a case where the data is equal to or less than a predetermined threshold or less than a predetermined threshold.

In another embodiment, in a case where the data is continuously equal to or less than a predetermined threshold or less than a predetermined threshold for a predetermined number of times or more (for example, a plurality of times, in particular, from two to 40 times, from three to 30 times or from four to 20 times), the information processing unit 103 determines that the clogging occurs in the sorting area.

Moreover, in another embodiment, in a case where the data is equal to or less than a predetermined threshold or less than a predetermined threshold within a predetermined time for a predetermined number of times or more (for example, a plurality of times, in particular, from two to 40 times, from three to 30 times or from four to 20 times), the information processing unit 103 determines that the clogging occurs in the sorting area.

The threshold may be appropriately selected according to, for example, the type of data related to the second detection particle number to be used. Since the clogging usually occurs after the sorting processing is performed for a certain period of time, the clogging does not occur in the initial time zone when the sorting processing is started, and the data related to the second detection particle number stably transitions. Therefore, the threshold may be appropriately set with reference to the data related to the second detection particle number in a time zone in which the clogging does not occur.

For example, in a case where the recovery rate, the average value thereof, the inverse, or the average value thereof is used as data related to the second detection particle number, the threshold may be set on the basis of the data related to the second detection particle number in the time zone in which the clogging does not occur.

Furthermore, regarding the change rate and the ratio, there is a high possibility that the clogging occurs in a case where the change rate significantly different from the change rate in the time zone in which the clogging does not occur is recorded. Therefore, a value lower than the change rate or the ratio in the time zone in which the clogging does not occur may be used as the threshold.

In a case where it is determined in step S102 that the clogging occurs in the sorting area, the information processing unit 103 advances the processing to step S103.

In a case where it is determined in step S102 that the clogging does not occur in the sorting area, the information processing unit 103 advances the processing to step S104.

In step S103, the biological sample analysis device 100 performs processing for removing the clogging in the sorting area. That is, the information processing unit 103 causes the biological sample analysis device 100 to perform the clogging removal processing in response to the determination that the clogging occurs in the sorting area. After completion of the processing, the biological sample analysis device 100 returns the processing to step S102. In this manner, the abnormality determination processing is repeated.

In the clogging removal processing in step S103, the biological sample analysis device 100 performs, for example, processing of changing (increasing or decreasing) the internal pressure in the chip 150, processing of changing the liquid delivery direction in the chip 150, or both of these processing. By such clogging removal processing, the disturbance of liquid in the chip occurs, and the clogging in the chip can be removed. Furthermore, these processing can be performed while maintaining a closed state, that is, can be performed without the biological sample coming into contact with the outside air. Therefore, sample loss can be prevented.

For example, in order to change the internal pressure, the biological sample analysis device 100 can open and close a valve provided in a flow channel for supplying the sample liquid and/or the sheath liquid, and/or increase or decrease the pressure of a pump for supplying the sample liquid and/or the sheath liquid.

Furthermore, the biological sample analysis device 100 can drive, for example, a pump for supplying the sample liquid and the sheath liquid so as to form opposite flows in order to perform processing of changing the liquid delivery direction. Specific operations for performing these processing may be appropriately selected by those skilled in the art according to the configuration of the biological sample analysis device 100.

In step S104, the biological sample analysis device 100 (particularly, the information processing unit 103) performs processing of detecting abnormality related to sample supply, and more specifically, performs supply area clogging determination processing of detecting the clogging in the supply area for supplying the biological sample to the sorting area where the particle sorting is performed. The information processing unit 103 detects the clogging on the basis of a change in clogging detection data. Here, the clogging detection data may be data related to the number of detected particles per unit time in the first detection region 156, that is, may be data related to the detection frequency of the analysis target particles.

The biological sample analysis device 100 may acquire the data every predetermined time, and may acquire the data, for example, every 0.1 seconds to 10 seconds, particularly every 0.5 seconds to five seconds, and more particularly every one second. In this way, by acquiring the data every predetermined time, a change in the data can be easily obtained, and the clogging can be more reliably detected.

In the first detection region 156, particles contained in the sample liquid are detected. A change in data related to the number of detected particles per unit time in the first detection region 156 (hereinafter also referred to as “first detection particle number”) is useful for detecting the clogging in the supply area. By detecting the change in the data related to the first detection particle number, the clogging can be detected, and further, it can be specified that the clogging exists in the supply area (for example, in the flow channel from a bag containing the sample liquid to a first detection region of the chip 150).

In step S104, the information processing unit 103 may compare the clogging detection data with a predetermined threshold in order to determine whether the clogging occurs.

For example, in step S104, the information processing unit 103 may compare the clogging detection data with a predetermined threshold to determine whether the clogging occurs in the supply area. For example, the information processing unit 103 may determine that the clogging occurs in the supply area in a case where the value used as the clogging detection data is equal to or less than a predetermined threshold or less than a predetermined threshold, or equal to or more than a predetermined threshold or more than a predetermined threshold.

That is, the change in the clogging detection data for determining the occurrence of the clogging may indicates that the clogging detection data is equal to or less than a predetermined threshold or less than a predetermined threshold, or equal to or more than a predetermined threshold or more than a predetermined threshold.

The data related to the first detection particle number may be, for example, the “number of detected particles to be analyzed per unit time” itself, that is, data related to the detection frequency of the analysis target particles.

Here, the “number of detected particles to be analyzed per unit time” corresponds to the “first detection particle number per unit time” described above.

The data related to the first detection particle number may be, for example, any of pieces of the data described below:
a change rate of a first detection particle number;
an average value of a plurality of the first detection particle numbers acquired in a predetermined time;
a change rate of the average value of a plurality of the first detection particle numbers acquired in the predetermined time; and
a ratio between an average value of a plurality of the first detection particle numbers acquired in the predetermined time and a reference average value.

Furthermore, the data based on the recovery rate may be a maximum value, a minimum value, or both of these values within a predetermined time. For example, the data based on the recovery rate may be a maximum value of the first detection particle number, a minimum value of the first detection particle number, or both of these values of the first detection particle numbers, or a value calculated using the maximum value and the minimum value (for example, a difference thereof or a ratio of the difference to the maximum value).

Such data is useful for detecting the occurrence of clogging in the supply area. Regarding the average value, the predetermined time may be appropriately set, but the predetermined time may range from, for example, five seconds to five minutes, 10 seconds to three minutes, or 20 seconds to two minutes.

The average value may be a moving average value of the first detection particle number continuously acquired in a predetermined time. For example, the first detection particle number is acquired every one second, and the moving average value of 10 recovery rates acquired over 10 seconds may be used as the average value.

Furthermore, the change rate of the average value may be a value indicating how much the first detection particle number (or the average value thereof) acquired at a certain time point has changed as compared with the first detection particle number (or the average value thereof) acquired at a previous time point. For example, the change rate may be a value represented by the following formula.

Change rate=(Difference between first detection particle number (or average value thereof) acquired at certain time point and first detection particle number (or average value thereof) acquired at previous time point)/(first detection particle number (or average value thereof) acquired at previous time point).

Regarding the ratio between the average value and the reference average value, the reference average value may be any average value in a time zone in which clogging does not occur, and may be, for example, an average value acquired first after the sorting processing is started. The reference average value may be changed every time a predetermined time elapses, or may be changed every time the change is detected.

The information processing unit 103 acquires data related to the first detection particle number at predetermined time intervals, and compares the data with a predetermined threshold.

In one embodiment, the information processing unit 103 determines that the clogging occurs in the sorting area in a case where the data is equal to or less than a predetermined threshold or less than a predetermined threshold.

In another embodiment, in a case where the data is continuously equal to or less than a predetermined threshold or less than a predetermined threshold for a predetermined number of times or more (for example, a plurality of times, in particular, from two to 40 times, from three to 30 times or from four to 20 times), the information processing unit 103 determines that the clogging occurs in the sorting area.

Moreover, in another embodiment, in a case where the data is equal to or less than a predetermined threshold or less than a predetermined threshold within a predetermined time for a predetermined number of times or more (for example, a plurality of times, in particular, from two to 40 times, from three to 30 times or from four to 20 times), the information processing unit 103 determines that the clogging occurs in the sorting area.

The threshold may be appropriately selected according to, for example, the type of data related to the first detection particle number to be used. As in the case of the data related to the second detection particle number, the threshold may be appropriately set with reference to the data related to the first detection particle number in a time zone in which the clogging does not occur.

For example, in a case where the first detection particle number itself is used as the data related to the first detection particle number, the threshold may be set on the basis of the data related to the first detection particle number in a time zone in which the clogging does not occur, and for example, any value ranging from 50% to 90% of any first detection particle number in the time zone, particularly any value ranging from 60% to 80% may be used as the threshold.

Furthermore, regarding the change rate and the ratio, there is a high possibility that the clogging occurs in a case where the change rate significantly different from the change rate in the time zone in which the clogging does not occur is recorded. Therefore, a value lower than the change rate or the ratio in the time zone in which the clogging does not occur may be used as the threshold.

In a case where it is determined in step S104 that the clogging exists in the supply area, the biological sample analysis device 100 (particularly, the information processing unit 103) advances the processing to step S105.

In a case where it is determined in step S104 that the clogging does not exist in the supply area, the biological sample analysis device 100 (particularly, the information processing unit 103) returns the processing to step S102. In this manner, the abnormality determination processing is repeated.

In step S105, the biological sample analysis device 100 (particularly, the information processing unit 103) performs bubble detection processing for detecting bubbles. The bubble detection processing is performed on the basis of the light detected in the first detection region 156.

The change in the data related to the first detection particle number may not be caused by clogging in the supply area but may be caused by the sample liquid shortage. Here, the detection of bubbles can be used as an index indicating that the sample liquid is used up. Therefore, by executing step S105, it is possible to determine whether the change in the data related to the first detection particle number is caused by the clogging in the supply area or is caused by the sample liquid shortage. As described above, the abnormality determination processing according to the present disclosure may include the bubble detection processing of detecting bubbles flowing in the flow channel.

The bubble detection may be performed on the basis of, for example, a trigger time of light (for example, scattered light, in particular, forward scattered light) detected in the first detection region 156. The trigger time may be a time when the signal intensity of the detected light is equal to or greater than a predetermined signal intensity threshold or greater than a predetermined signal intensity threshold.

In a case where the trigger time is equal to or more than a predetermined time threshold or more than a predetermined time threshold, the information processing unit 103 may determine that the light in which the trigger time is recorded is light generated by irradiating bubbles with light, that is, in this case, it may be determined that bubbles are detected. As described above, the bubble detection processing may be performed on the basis of scattered light generated by irradiating the analysis target particles with light.

The information processing unit 103 may determine that the bubbles are detected in a case where a ratio of the number of times of detection of the bubbles to the total number of events in a unit time is equal to or greater than a predetermined threshold. The ratio may be a ratio to the total number of detections in first detection region 156 per unit time.

Since the bubble detection performed only once may not mean that the sample has been used up, more appropriate determination can be performed by using the ratio as an index for bubble detection determination.

A more detailed example of the bubble detection processing is described in Patent Document 1, and the contents thereof may be incorporated in the present disclosure.

In a case where it is determined in step S105 that the bubbles are detected, the biological sample analysis device 100 (particularly, the information processing unit 103) advances the processing to step S106.

In a case where it is determined in step S105 that the bubbles are not detected, the biological sample analysis device 100 (particularly, the information processing unit 103) advances the processing to step S107.

In step S106, the biological sample analysis device 100 performs supply flow channel cleaning processing. In order to perform the supply flow channel cleaning processing, the biological sample analysis device 100 may perform, for example, backflow processing of causing the sheath liquid to flow backward. In order to perform the backflow processing, the information processing unit 103 may drive a pump for supplying the sample liquid in a reverse direction.

After the supply flow channel cleaning processing is performed, the biological sample analysis device 100 advances the processing to step S107.

In step S107, the biological sample analysis device 100 ends the liquid delivery processing (that is, the sorting processing). In a case where bubbles are detected in this manner, the biological sample analysis device 100 may end the sorting processing.

In step S108, the biological sample analysis device 100 performs processing for removing the clogging in the supply area. After completion of the processing, the biological sample analysis device 100 returns the processing to step S102. In this manner, the abnormality determination processing is repeated.

In the clogging removal processing in step S108, the biological sample analysis device 100 may perform, for example, backflow processing of causing the sheath liquid to flow backward into the sample flow channel. In order to perform the backflow processing, the information processing unit 103 may drive a pump for supplying the sample liquid in a reverse direction. Therefore, it is possible to remove the clogging in the flow channel through which the sample liquid flows.

For example, the clogging may be caused since the biological particles, particularly the cells in the sample liquid adheres to the flow channel wall. By the backflow processing, such biological particles can be returned to the container in which the sample liquid is stored.

Then, the processing returns to step S102 as described above, and the liquid delivery processing is subsequently performed, and thus the recovery rate of the biological particles can be improved.

By performing the abnormality determination processing as described above, the clogging in the flow channel can be detected. Moreover, it is possible to specify an area where the clogging occurs and to perform processing corresponding to the clogging. Moreover, this abnormality determination processing can be performed in a closed chip. Moreover, in this abnormality determination processing, loss of the sample can be reduced, a bleaching agent is not supplied, and thus adverse effects on the sample are also reduced.

### (5) Second Example of Abnormality Determination Processing

A second example of the abnormality determination processing executed by the biological sample analysis device according to the present disclosure will be described below with reference to FIGS. 2 and 15. FIG. 2 is as described above. FIG. 15 is a flowchart of the abnormality determination processing.

Steps S201 to S208 illustrated in FIG. 15 are the same as steps S101 to S108 in FIG. 14 except for the processing in the following step S204, and the description thereof is also applied to the present example. Therefore, the descriptions of steps S201 to S208 are omitted. In step S204, in a case where it is determined in step S204 that the clogging does not exist in the supply area, the biological sample analysis device 100 (particularly, the information processing unit 103) advances the processing to step S209.

In step S209, the information processing unit 103 determines whether a predetermined time has elapsed from the time point when the liquid delivery in step S201 is started.

In response to the determination that the predetermined time has elapsed, the information processing unit 103 advances the processing to step S210.

In response to the determination that the predetermined time does not elapse, the information processing unit 103 returns the processing to step S202. In this manner, the abnormality determination processing is repeated.

In step S210, the biological sample analysis device 100 performs supply flow channel cleaning processing. Since the cleaning processing is performed according to the elapse of the predetermined time, the cleaning processing is also referred to as periodic cleaning processing. In order to perform the cleaning processing, the biological sample analysis device 100 may perform, for example, backflow processing of causing the sheath liquid to flow backward. In order to perform the backflow processing, the information processing unit 103 may drive a pump for supplying the sample liquid in a reverse direction. Thus, the biological particles in the sample flow channel can be recovered into a container containing the sample liquid and subjected to sorting again. Therefore, the recovery rate of the biological particles can be increased.

After execution of the cleaning processing, the biological sample analysis device 100 returns the processing to step S202. In this manner, the abnormality determination processing is repeated.

As described above, the biological sample analysis device 100 according to the present disclosure may be designed to periodically repeat the cleaning processing. Thus, the biological particles such as cells adhering to the sample flow channel are periodically removed. Then, the adhering biological particles may be recovered into a solution containing the sample liquid and subjected to the sorting processing again. Therefore, the recovery rate can be increased.

### 2. Second Embodiment (Abnormality Determination Method)

The present disclosure provides an abnormality determination method in the biological sample analysis device. The abnormality determination method includes performing abnormality determination processing of detecting an abnormality in a flow channel through which a biological sample flows on the basis of clogging detection data. Here, the clogging detection data may be data based on the number of detected particles per unit time. The abnormality determination method according to the present disclosure may be performed by, for example, the biological sample analysis device described in (2) and (3) of 1. described above, but may be performed by other devices.

In one embodiment, the abnormality determination method according to the present disclosure may include sorting area clogging determination processing for detecting clogging in the sorting area where particles are sorted.

Furthermore, in another embodiment, the abnormality determination method according to the present disclosure may include supply area clogging determination processing for detecting clogging in the supply area for supplying the biological sample to the sorting area where the particles are sorted.

In a particularly preferred embodiment, the abnormality determination method according to the present disclosure may include both the sorting area clogging determination processing and the supply area clogging determination processing.

The abnormality determination processing according to the present disclosure may be performed according to, for example, the flow described in (4) or (5) of 1. described above, but other flows may be adopted.

Furthermore, the present disclosure provides a program for causing the biological sample analysis device to perform the abnormality determination method. That is, the program causes the biological sample analysis device to perform abnormality determination processing of detecting an abnormality in the flow channel through which the biological sample flows on the basis of a change in the clogging detection data, and the clogging detection data is data based on the number of detected particles per unit time.

Note that the present disclosure can also have the following configurations.

[1]

A biological sample analysis device
including an information processing unit configured to perform abnormality determination processing of detecting an abnormality in a flow channel through which a biological sample flows on the basis of clogging detection data, in which
the clogging detection data is data related to the number of detected particles per unit time.
   [2]

The biological sample analysis device according to [1], in which
the clogging detection data includes at least one of
data related to the number of detected particles sorted per unit time,
data related to the number of particles determined to be sorting targets per unit time, and data related to the number of detected particles to be analyzed per unit time.
   [3]

The biological sample analysis device according to [1], in which
the abnormality determination processing includes at least one of
sorting area clogging determination processing for detecting clogging in a sorting area where the particles are sorted,
supply area clogging determination processing for detecting clogging in a supply area for supplying the biological sample to the sorting area, or
bubble detection processing for detecting bubbles flowing in the flow channel.
   [4]

The biological sample analysis device according to [3], in which the abnormality determination processing further includes the bubble detection processing of detecting bubbles flowing in the flow channel.

[5]

The biological sample analysis device according to [1], in which the abnormality determination processing includes sorting area clogging determination processing for detecting clogging in a sorting area where the particles are sorted.

[6]

The biological sample analysis device according to [5], in which the clogging detection data is data based on the number of particles determined to be sorting targets per unit time and the number of detected particles sorted per unit time.

[7]

The biological sample analysis device according to [5] or [6], in which the clogging detection data is data based on a recovery rate of sorting target particles.

[8]

The biological sample analysis device according to any one of [5] to [7], in which the information processing unit compares the clogging detection data with a predetermined threshold to determine whether the clogging occurs in the sorting area.

[9]

The biological sample analysis device according to any one of [5] to [8], in which the information processing unit compares the clogging detection data with a predetermined threshold, and determines that the clogging occurs in the sorting area in a case where the clogging detection data is continuously detected to be equal to or less than the predetermined threshold or less than the predetermined threshold for a predetermined number of times, or in a case where the clogging detection data is detected a predetermined number of times or more within a predetermined time.

[10]

The biological sample analysis device according to any one of [5] to [79, in which the information processing unit causes the biological sample analysis device to perform clogging removal processing in response to the determination that the clogging occurs in the sorting area.

[11]

The biological sample analysis device according to [1], in which the abnormality determination processing includes supply area clogging determination processing for detecting clogging in a supply area for supplying the biological sample to a sorting area where the particles are sorted.

[12]

The biological sample analysis device according to [11], in which the clogging detection data is data related to a detection frequency of analysis target particles.

[13]

The biological sample analysis device according to [11] or [12], in which the information processing unit compares the clogging detection data with a predetermined threshold to determine whether the clogging occurs in the supply area.

[14]

The biological sample analysis device according to any one of [11] to [13], in which the information processing unit compares the clogging detection data with a predetermined threshold, and determines that the clogging occurs in the supply area in a case where the clogging detection data is continuously detected to be equal to or less than the predetermined threshold or less than the predetermined threshold for a predetermined number of times, or in a case where the clogging detection data is detected a predetermined number of times or more within a predetermined time.

[15]

The biological sample analysis device according to any one of [11] to [14], in which in a case where it is determined that the clogging occurs in the supply area clogging determination processing, the information processing unit performs bubble detection processing.

[16]

The biological sample analysis device according to [15], in which the bubble detection processing is performed on the basis of scattered light generated by irradiating analysis target particles with light.

[17]

The biological sample analysis device according to [15] or [16], in which the information processing unit ends sorting processing in a case where bubbles are detected in the bubble detection processing.

[18]

The biological sample analysis device according to any one of [11] to [17], in which the information processing unit causes the biological sample analysis device to perform clogging removal processing in response to the determination that the clogging occurs in the supply area.

[19]

An abnormality determination method in a biological sample analysis device, the method including
performing abnormality determination processing of detecting an abnormality in a flow channel through which a biological sample flows on the basis of clogging detection data, in which
the clogging detection data is data related to the number of detected particles per unit time.

### REFERENCE SIGNS LIST

100 Biological sample analysis device
101 Light irradiation unit
102 Detection unit
103 Information processing unit

1. A biological sample analysis device
comprising an information processing unit configured to perform abnormality determination processing of detecting an abnormality in a flow channel through which a biological sample flows on a basis of clogging detection data, wherein
the clogging detection data is data related to the number of detected particles per unit time.

2. The biological sample analysis device according to claim 1, wherein
the clogging detection data includes at least one of
data related to the number of detected particles sorted per unit time,
data related to the number of particles determined to be sorting targets per unit time, and
data related to the number of detected particles to be analyzed per unit time.

3. The biological sample analysis device according to claim 1,
wherein the abnormality determination processing includes at least one of
sorting area clogging determination processing for detecting clogging in a sorting area where the particles are sorted,
supply area clogging determination processing for detecting clogging in a supply area for supplying the biological sample to the sorting area, or
bubble detection processing for detecting bubbles flowing in the flow channel.

4. The biological sample analysis device according to claim 3, wherein the abnormality determination processing further includes the bubble detection processing of detecting bubbles flowing in the flow channel.

5. The biological sample analysis device according to claim 1, wherein the abnormality determination processing includes sorting area clogging determination processing for detecting clogging in a sorting area where the particles are sorted.

6. The biological sample analysis device according to claim 5, wherein the clogging detection data is data based on the number of particles determined to be sorting targets per unit time and the number of detected particles sorted per unit time.

7. The biological sample analysis device according to claim 5, wherein the clogging detection data is data based on a recovery rate of sorting target particles.

8. The biological sample analysis device according to claim 5, wherein the information processing unit compares the clogging detection data with a predetermined threshold to determine whether the clogging occurs in the sorting area.

9. The biological sample analysis device according to claim 5, wherein the information processing unit compares the clogging detection data with a predetermined threshold, and determines that the clogging occurs in the sorting area in a case where the clogging detection data is continuously detected to be equal to or less than the predetermined threshold or less than the predetermined threshold for a predetermined number of times, or in a case where the clogging detection data is detected a predetermined number of times or more within a predetermined time.

10. The biological sample analysis device according to claim 5, wherein the information processing unit causes the biological sample analysis device to perform clogging removal processing in response to the determination that the clogging occurs in the sorting area.

11. The biological sample analysis device according to claim 1, wherein the abnormality determination processing includes supply area clogging determination processing for detecting clogging in a supply area for supplying the biological sample to a sorting area where the particles are sorted.

12. The biological sample analysis device according to claim 11, wherein the clogging detection data is data related to a detection frequency of analysis target particles.

13. The biological sample analysis device according to claim 11, wherein the information processing unit compares the clogging detection data with a predetermined threshold to determine whether the clogging occurs in the supply area.

14. The biological sample analysis device according to claim 11, wherein the information processing unit compares the clogging detection data with a predetermined threshold, and determines that the clogging occurs in the supply area in a case where the clogging detection data is continuously detected to be equal to or less than the predetermined threshold or less than the predetermined threshold for a predetermined number of times, or in a case where the clogging detection data is detected a predetermined number of times or more within a predetermined time.

15. The biological sample analysis device according to claim 11, wherein in a case where it is determined that the clogging occurs in the supply area clogging determination processing, the information processing unit performs bubble detection processing.

16. The biological sample analysis device according to claim 15, wherein the bubble detection processing is performed on a basis of scattered light generated by irradiating analysis target particles with light.

17. The biological sample analysis device according to claim 15, wherein the information processing unit ends sorting processing in a case where bubbles are detected in the bubble detection processing.

18. The biological sample analysis device according to claim 11, wherein the information processing unit causes the biological sample analysis device to perform clogging removal processing in response to the determination that the clogging occurs in the supply area.

19. An abnormality determination method in a biological sample analysis device, the method comprising
performing abnormality determination processing of detecting an abnormality in a flow channel through which a biological sample flows on a basis of clogging detection data, wherein
the clogging detection data is data related to the number of detected particles per unit time.
